(19) United States
(12) Patent Application Publication
(10) Pub. No.: US 2005/0261991 A1
(43) Pub. Date: Nov. 24, 2005

(54) Monitoring and tracking system and method

(76) Inventor: Jack J. Kennamer, Maineville, OH (US)

Correspondence Address: ALIX YALE & RISTAS LLP, 750 MAIN STREET, SUITE 1400, HARTFORD, CT, 06103, US

(21) Appl. No.: 10/662,642

(22) Filed: Sep. 15, 2003

Related U.S. Application Data
(62) Division of application No. 09/573,764, filed on May 18, 2000, now abandoned.
(60) Provisional application No. 60/178,056, filed on Jan. 24, 2000.
(60) Provisional application No. 60/158,785, filed on Oct. 12, 1999.

(51) Int. Cl. G06F 17/60

(52) U.S. Cl. 705/28

(57) ABSTRACT

A hand-held data collector having a sensor, for example, a temperature sensor, a reader, for example, a bar code scanner, a user I/O device, a data processor in electrical communication with the sensor, the reader and the user I/O device and a transceiver unit in electrical communication with the data processor. The data processor receiving information from the sensor and the reader. The data collector transmits the read and sensed information over a communication link to a computer where the data is analyzed and stored. In a food processing facility, the above monitoring and tracking system may be used to monitor, track, analyze and provide a real time reporting of temperatures and locations of specific food items in inventory. Each time the food location is changed, a new expiration date for the food item is automatically calculated and applied to a new food rotation label. Further, the history of food items from a manufacturer's food lot number can be quickly reported.

This application claims priority to the application U.S. Ser. No. 60/178,056, entitled, “Inventory and Temperature Tracking System”, filed on Jan. 24, 2000 and the application of U.S. Ser. No. 60/158,785, entitled, “Inventory and Temperature Tracking System”, filed on Oct. 12, 1999; the entire disclosures of which are hereby incorporated by reference herein.

### FIELD OF THE INVENTION

The present invention generally relates to monitoring systems and more particularly, to a monitoring and tracking system normally used in the food industry

### BACKGROUND OF THE INVENTION

Food processing, serving, storing, transportation and warehousing facilities must be constantly vigilant of the temperature of the food being handled. Food temperature specifications are recommended for the cold storage, cooking and warming of food. Further, there are recommended specifications for the maximum time periods for which foods can be kept at temperatures other than the recommended temperatures. Such temperature specifications also determine the longest period of time that can be used to raise or lower the temperature of food between recommended temperatures. Failure to maintain food at the proper temperature often results in loss of desired texture and taste, spoilage and/or food born illness which requires more labor, special handling and adds inefficiencies and cost to food handling, preparation and serving processes.

Thus, the handling of food requires a constant monitoring of its temperature and/or the temperature of the ambient air in which the food is being stored, for example, cold storage air temperature. The collection and maintenance of temperature data is accomplished using various instruments and is generally very labor intensive. There are known devices for measuring temperatures and automatically recording those temperatures on a paper chart; however, such devices have relatively limited applications.

It is also known to use inspectors who carry portable temperature data collection devices that include a temperature measuring sensor and a data storage device, for example, a digital processor with memory that maintains a digital record of the temperatures measured. The inspectors use the temperature sensor to measure the temperature of the food at different times and at different stages of the food handling, preparation and serving processes. Historical temperature records are kept either manually or are entered into a computer for storage and reporting. Recommended temperatures in food handling and preparation processes are set forth in an FDA Model Food Code. While the Food Code provides a recommended temperature model, it does not specify any implementation of the model. One widely used implementation of the Food Code model is an HACCP (Hazard Analysis and Critical Control Points) analysis. The exact implementation of an HACCP analysis will vary from user to user depending of the nature of the food items, the size of the facility, etc. However, any implementation of an HACCP analysis and associated data collection is very labor intensive and prone to errors. Thus, there is a need for a convenient method and system for tracking temperatures of food items at different locations and providing a historical temperature record of the food item.

Known temperature measuring systems only measure and maintain a record of the temperature at a location, for example, a cooler, cooking station, serving station, etc.; and there is no association of the measured temperature with specific food items being stored, prepared and/or served. However, in every food handling and food processing facility, it is necessary to keep track of the shelf life of each food item in inventory; and the food items must be rotated or used so that the oldest food items are used before they exceed their recommended shelf life. Further, the shelf life of a food item is a variable that is constantly changing as the food item moves through a food handling and processing facility. Food items are normally identified as food types, for example, meats, dairy products, frozen vegetables, fresh fruits, cooked foods, etc. Further, the food items are initially located in a freezer, a deep chiller, a refrigerator, dry storage, etc.; and thus, each food item has an initial shelf life depending on its type and initial location. However, the shelf life of a food item changes as it moves through a food processing facility. For example, a diary product is often received in a deep chiller and has a shelf life in the chiller of 15 days. If after 10 days, the dairy product is moved to a refrigerator; it's shelf life will change. For example, a dairy product has a shelf life of 10 days in a refrigerator. However, after 10 days in the deep chiller, this dairy product only has 5 days of shelf life left; and therefore, only has five days of shelf life available in the refrigerator. Therefore, this dairy product has an expiration date that is five days after the date that it is placed in the refrigerator; and if it is not consumed by the expiration date, it must be discarded as spoiled. Thus, as can be appreciated, tracking the shelf life and expiration dates of all of the food items in a food handling and processing facility is a substantial undertaking.

Currently, such tracking is done manually, and most often, as food is moved through the food handling and processing facility, the expiration dates are recalculated and handwritten on a label which is applied to the package or container of the food item. As will be appreciated, any operation that is so labor intensive often results in errors, and loss of food due to exceeded expiration dates is relatively common. Therefore, there is a need for a convenient method of automatically tracking shelf lives and expiration dates of food items as they move to different locations in a food handling and processing facility.

Occasionally, a manufacturer of a food item discovers that the food item was tainted during a manufacturing process, and the manufacturer then issues a recall of all food items that were manufactured in the same lot as the tainted food item sample. Normally, all of the food items manufactured in the same lot will share a common lot number. Hence, the manufacturer's recall will refer to a lot number that is reproduced on the packaging of the food item. A food handling and processing facility normally does not record such lot numbers. Hence, if a recall notice is issued, the food handling and processing facility undertakes a manual inspection of all related food item packages to determine whether any food items with the recalled lot number are in inventory, If so, the food items are removed from inventory. If not, it is assumed that the food items from the recalled lot number were either not received or were consumed. Thus, if the food handling and processing facility experiences complaints with respect to its prepared and consumed food, it has no way of verifying whether the food items used came from the recalled lot. Thus, there is a need for a convenient way of determining whether food items associated with different lot numbers were ever received by a food handling and processing facility. Further, if food items from a recalled lot were received and used and complaints are received, there is a need for a convenient way of determining when, and in what recipes, the food items from a recalled lot were consumed.

There is also a need for a single, integrated system that tracks food items, temperatures, expiration dates and lot numbers as the food items are handled throughout a food preparation and consumption process.

### SUMMARY OF INVENTION

The present invention provides a monitoring and tracking system that permits a user to have accurate and immediate access to a reporting of all of current inventory, its history and current shelf life. If the inventory is temperature sensitive, the monitoring and tracking system of the present invention permits temperature readings to be easily taken and stored. Measured temperatures that are out of a desired range are immediately reported so that corrective action may be taken. The monitoring and tracking system of the present invention is very flexible and can be structured to any user's needs. Further, with the monitoring and tracking system of the present system, product rotation is optimized so that product spoilage can be virtually eliminated. Thus, with more efficient use of the products in inventory, operating costs can be substantially reduced. The monitoring and tracking system of the present invention is especially useful in the food industry.

In accordance with the principles of the present invention and the described embodiments, the invention provides a hand-held data collector having a sensor, for example, a temperature sensor, a reader, for example, a bar code scanner, a user I/O device, a data processor in electrical communication with the sensor, the reader and the user I/O device, and a transceiver unit in electrical communication with the data processor, the data processor receiving information from the sensor and the reader. Thus, with a single portable, hand-held device, a user can, anywhere in a facility, read a bar code on a food package and measure the temperature of the food package. In one aspect of this embodiment of the invention, the data collector can be connected to a printer, for example, a bar code label printer, so that a new food package label can be printed.

In another embodiment of the invention, the above data collector is connected to a computer via a communications link. Thus, the measured temperature and bar code information are transferred to the computer for analysis and storage. In one aspect of this embodiment, the communications link includes a wireless communications link with the data collector.

A further embodiment of the invention provides a method of tracking temperatures of a food item in which identity data identifying the food item is created and a temperature value of the food item is measured with a temperature measuring device. Next, the temperature value of the food item is transmitted to a computer and stored in association with the identity data, so that a record of the temperature of the food item is maintained. In one aspect of this invention, the temperature of the food item is measured with a hand-held data collector. Thus, the monitoring and tracking system of the present invention has the advantages of continuously, very accurately and reliably monitoring and tracking temperatures in association with a food item which heretofore was only performed manually.

In a still further embodiment of the invention, a method is provided for monitoring and tracking shelf life for a food item by providing identity data identifying a food item, identifying a first location of the food item, and automatically determining a shelf life for the food item as a function of the identity of the first location. In one aspect of this embodiment, the method determines a first date on which the food item is placed at the first location, and then, automatically determines a first expiration date for the food item as a function of the identity of the first location and the first date. Thus, the method permits food rotation to be optimized, so that ingredients with the oldest expiration dates can be accurately and quickly found and spoilage of food in inventory can be eliminated. Further, the present invention permits new product rotation labels to be accurately and quickly printed on the floor at the location where the label is to be applied. Further, such labels include all pertinent information in coded as well as human readable form so that the information on the label can be accurately and quickly entered into the system by a scanning process.

In yet another embodiment of the invention, a method of monitoring and tracking a food lot number for a food item is provided that first provides and stores, in a monitoring and tracking system, identity data identifying food items and food lot numbers associated with respective ones of the food items. Each food lot number identifies a specific lot from which the food item was made by a particular manufacturer. The method next generates a report using the monitoring and tracking system to identify the food items associated with a lot number input by a user. Thus, the system has the advantage of accurately and quickly being able to identify recalled food items as well as accurately verify whether complaints correspond to the use of recalled food items in specific recipes on specific days. Thus, any such complaints can be expeditiously handled with a high level of confidence and certainty.

Various additional advantages, objects and features of the invention will become more readily apparent to those of ordinary skill in the art upon consideration of the following detailed description of the presently preferred embodiments taken in conjunction with the accompanying drawings.

### BRIEF DESCRIPTION OF DRAWINGS

FIG. 1 is a schematic block diagram of a portable, hand-held data collection system in accordance with the principles of the present invention.

FIG. 2 is perspective view of the portable, hand-held data collector used in the system of FIG. 1.

FIG. 3 is a flow chart illustrating a process for using the monitoring and tracking system in accordance with the principles of the present invention.

FIG. 4 is a schematic showing of a product list table similar to one maintained by the monitoring and tracking system of FIG. 1.

FIG. 5 is a schematic showing of a food inventory table similar to one maintained by the monitoring and tracking system of FIG. 1.

FIG. 6 is a schematic showing of a probe temperature and alert table similar to one maintained by the monitoring and tracking system of FIG. 1.

FIG. 7 is a schematic showing of a maximum shelf life table similar to one maintained by the monitoring and tracking system of FIG. 1.

FIG. 8 is a schematic showing of a sensor temperature and alert table similar to one maintained by the monitoring and tracking system of FIG. 1.

### DETAILED DESCRIPTION OF THE INVENTION

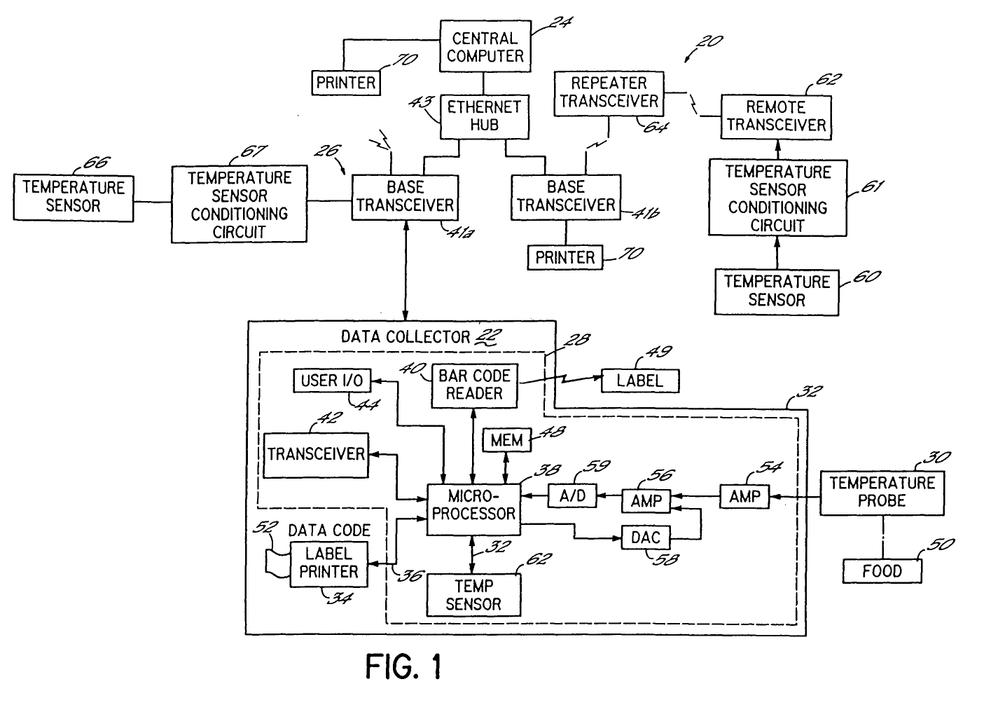

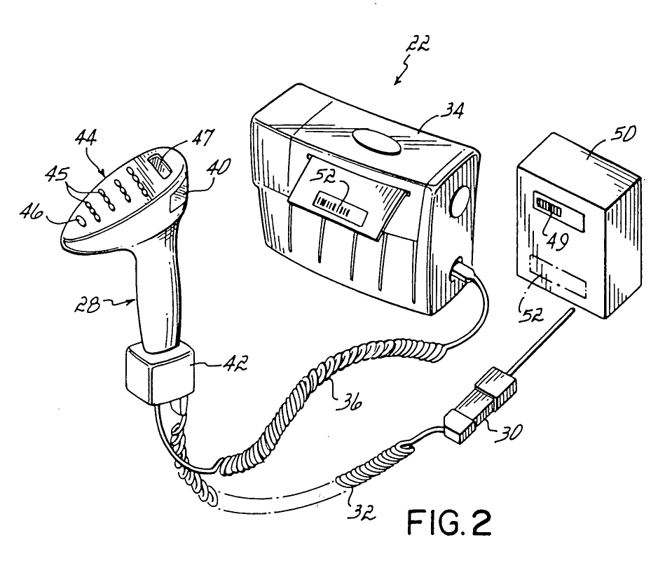

Referring to FIG. 1, a monitoring and tracking system 20 includes a portable hand-held data collector 22, a central computer 24 and a communications link 26 providing electrical communications between the data collector 22 and central computer 24. Referring to FIGS. 1 and 2, the data collector comprises a main body including a pistol grip 28, a temperature sensing probe 30 electrically connected to the body 28 by a communications link 32 and a printer 34 electrically connected to the body unit 28 by a communications link 36. The main body 28 of the data collector 22 has a data processor 38, for example, an 8 bit PIC microcontroller, mounted therein. The microcontroller 38 is in electrical communication with a reader 40, for example, a bar code reader and a communications unit 42, for example, a wireless transmitter/receiver or transceiver. The transceiver 42 is a UHF, for example, a line-of-sight 900 MHz, transceiver. In a known manner, the transceiver 42 uses two transmitters that are close in frequency, for example, 906 MHz and 915 MHz. The microcontroller 38 initiates communications using one transmitter; however, if a link cannot be established, the microcontroller 38 then initiates communications with the second transmitter. The output of the transmitters is amplified and filtered in an LC filter in a known manner prior to feeding an antenna. The transceiver 42 and all other transceivers in the system comply with FCC regulations.

In addition to its internal memory, the microcontroller 38 is connected to external memory 48 which normally is a nonvolatile memory such as an EEPROM. The microcontroller 38 is also in electrical communications with user input/output (“I/O”) devices 44. The user I/O 44 can include a user input device, for example, a pushbutton and/or keypad 45, or an output device, for example, an audio sound generator 46, or a display 47, such as an LCD screen, etc. The keypad 45 normally has a set of keys or pushbuttons that in a known manner have alpha/numeric or functional identities.

The temperature probe 30 and the other temperature sensors identified herein may detect temperature is several different ways. For example, the temperature probe 30 may be a resistance temperature device, a thermocouple, an infrared detector, etc; however, in the described embodiment, the temperature probe 30 uses a thermocouple to detect changes in temperature of the food. An analog temperature signal from the thermocouple temperature probe 30 is amplified by an analog operational amplifier (“op amp”) 54. A second op amp 56 operates with a digital to analog converter (“DAC”) 58 to provide an analog signal to a analog to digital (“AID”) converter 60 that is within the range of the A/D converter 60. The operation of the DAC 58 and op amp 56 permit the relatively narrow magnitude range of the AID converter 60 to accommodate the much wider magnitude range of the output signal from the thermocouple sensor 30. In operation, when the microcontroller 38 samples the output from the AID converter 60 and determines that the output is saturated or at its maximum value, the microcontroller 38 provides a known value to the DAC 58 which functions to offset or reduce the magnitude of the analog signal output from the op amp 56 by a fixed amount. The microcontroller 38 again checks the output from the A/D converter 60; and if it is still at a maximum, the microcontroller 38 increments the magnitude of the signal to the DAC 58 by another fixed amount. That process continues until the microcontroller 38 detects that the output from the AID converter 60 is no longer saturated. The microcontroller 38 then stores the output from the AID converter 60 with the amount of offset that it provided to the DAC 58.

The microcontroller 38 then samples a temperature reading from a second temperature sensor 62 that is sensing the ambient temperature. The temperature sensor 62 can also be implemented with several known temperature detection devices, but normally the temperature sensor 62 is a temperature sensing integrated circuit device. Given the ambient temperature measurement and the measurement from the thermocouple probe 30, the microcontroller 38 calculates the temperature value of the food. The microcontroller 38 then provides commands to the transceiver 42 to transfer the calculated temperature value of the food to the central computer 24 via the communications link 26.

In response to user input commands via the user I/O 44, the microcontroller 38 operates the bar code reader 40 to read a label 49 associated with the food 50. Automatically, at appropriate times or in response to instructions from the user via the user I/O 44, the microcontroller 38 transfers data over the communications link 26 to the central computer 24. The communications link 26 includes a remote transceiver 42, a base transceiver 41 and an ethernet hub or port 43. In addition, in response to user instructions provided via the user I/O 44, the microcontroller 38 commands the operation of the bar code label printer 34 which prints bar code labels 52 as required. The main body 28, including the user I/O 44 and bar code scanner 40, are commercially available from Symbol Technology of Holtsville, N.Y.

In addition to the temperature probe 30 of the data collector 22, other temperature measuring devices may be used to monitor food temperature during the food handling and preparation process. A temperature measuring device, for example, a temperature sensor, 60 is often permanently located in association with food storage device, for example, a freezer, a deep chiller, a refrigerator, etc. A sensor identical to the temperature sensor 60 may also be used to measure food temperature in a cooking pan or other container, a serving pot or bowl, or a salad bar. Temperature sensors can also be integrated within the structure of a cooking utensil, for example, a ladle or spoon. In this embodiment, the temperature sensor 60 is a thermocouple and is connected to a remote transceiver 62 via a temperature sensor conditioning circuit 61. The conditioning circuit 61 is comprised of circuits identical to the op amps 54, 56, DAC 58 and A/D converter 60 within the data collector 22 and operate as previously described. While only a single temperature sensor 60 is illustrated as being connected to the remote transceiver 62, as will be appreciated the remote transceiver 62 may be designed to be connected to and service a plurality of temperature sensors each with its own temperature sensor conditioning circuit.

The remote transceiver 62 includes a PIC microcontroller, ambient temperature sensor and external memory similar to the microcontroller 38, temperature sensor 62 and memory 48, respectively. The PIC microcontroller in the transceiver 62 operates in a manner similar to microcontroller 38 previously described and thus, automatically measures the temperature of the food or other item which is in a heat conducting/radiating relationship with the thermocouple of the remote temperature sensor 60. The microcontroller in the transceiver 62, in the same manner as described with respect to the operation of the microcontroller 38, automatically transmits the measured temperature value and other data to a base transceiver 41b which, in turn, transmits the data to the central computer 24 via an ethernet hub 43. The measured temperature value is stored in the central computer 24 with a time and date stamp. In addition, with that data, the remote transceiver 62 also transmits a code identifying the transceiver 62 as well as the most recent measurement of the ambient temperature value.

The base transceiver 41b, as well as other base transceivers used in the monitoring and tracking system 20, are identical in construction. Each transceiver 41 has a PIC microcontroller and a transceiver unit similar to the microcontroller 38 and transceiver 42 previously described. However, the base transceiver 41 also communicates with an ethernet port and in addition, has a serial communications port that may be connected to another device, for example, a printer 70. To support those additional functions, each base transceiver 41 has a second data processor or central processing unit (“CPU”) and memory in electrical communications with the PIC microcontroller. The CPU manages the ethernet communications as well as managing other higher level protocols, for example, controlling the printer 70. In other locations, a temperature sensor 66 and temperature sensor conditioning circuit 67 may be connected directly to a base transceiver 41 a. In this embodiment, the temperature sensor 66 is a thermocouple; and therefore, the temperature sensor conditioning circuit 67 is identical to the temperature sensor conditioning circuit 61. Further, the microcontroller in the base transceiver 41 samples a temperature value from the temperature sensor 66 and transmits that value to the central computer 24 in an identical manner as previously described with respect to the operation of the microcontroller 38.

As previously described, the transceivers 42, 62 are line-of-sight transceivers which have a relatively short range; and therefore, it may be necessary to use one or more relay devices, such as a repeater 64, to transmit signals from the temperature sensor 60 or the data collector 22 to the central computer 24. The repeater is a relatively short range RE transceiver having the same construction and operation as the transceivers 42, 62 previously described.

The monitoring and tracking system 20 facilitates the monitoring and tracking of temperatures of identifiable food items and batches of prepared foods throughout the entire food handling, preparation and serving processes within a food preparation facility. Further, the monitoring and tracking system has the capability of entering and storing every step of every process a user is expected to perform in the central computer 24. For example, at the location where food items are received from a supplier, the user may execute one or more of the following processes: check-in process number 10—standard, check-in process number 11—with no temperature, check-in process number 12—without temperature validation, check-in process number 13—deep chill temperature, etc. Further, at that location, a placard is placed that displays bar codes for each of the processes to be executed at that location. Thus, to initiate a process, the user of the data collector 22 simply scans the bar code on the placard next to the identity of the desired process; or alternatively, the user can enter the process number, for example, 10, 11, 12, 13, etc., using the keypad 45. Once a process is initiated, the user of the data collector 22 is prompted through each step of the process by messages on the visual display 47 and audible signals. Thus, the process of handling incoming food items can be predetermined in exact detail.

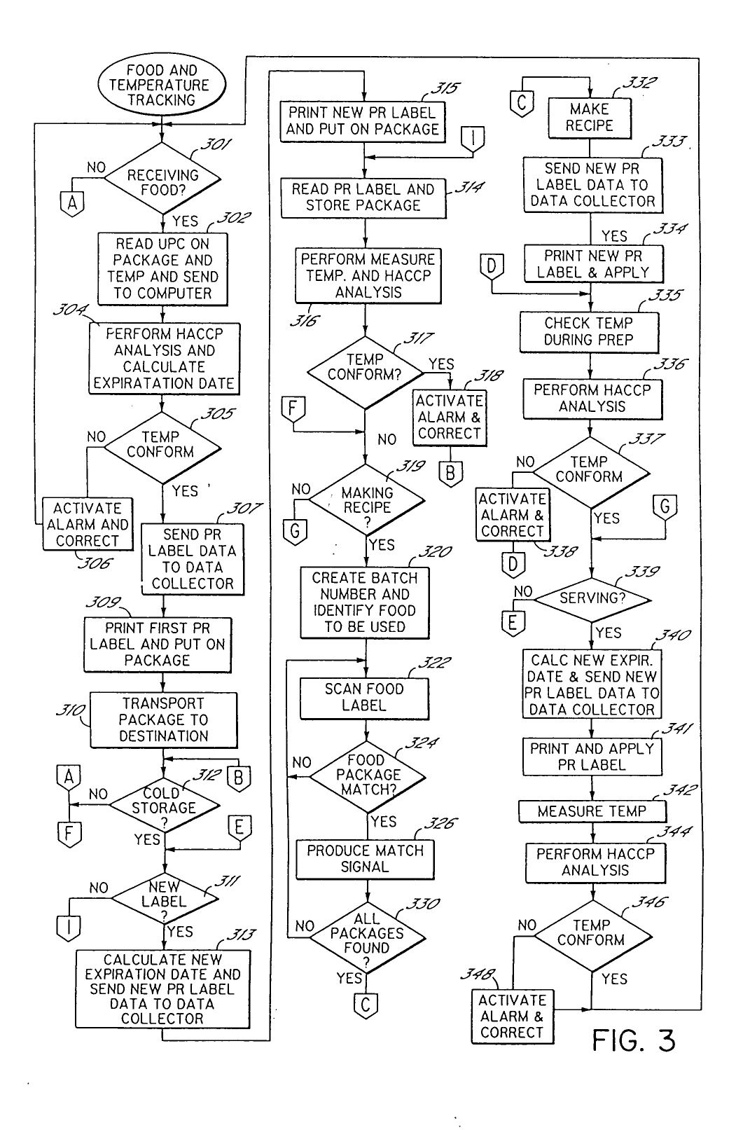

One embodiment of a food temperature monitoring and tracking process is illustrated in FIG. 3. Assuming the user has initiated a standard check-in process as described above, the user is first prompted, at 302, to scan the bar code on the food package. Normally, food is received in packages that contain a UPC bar code label identifying the manufacturer, the product and its price. The user orients the body 28 of the data collector 22 such that the scanner 40 is able to read the UPC bar code label 49 on the food package 50. That information is decoded by the microcontroller 38; and the microcontroller 38 initiates a transfer of the bar code data via the remote transceiver 42, base transceiver 41a and ethernet hub 43 to the central computer 24. The information read from the UPC label 49 can be displayed to the user via the display 47.

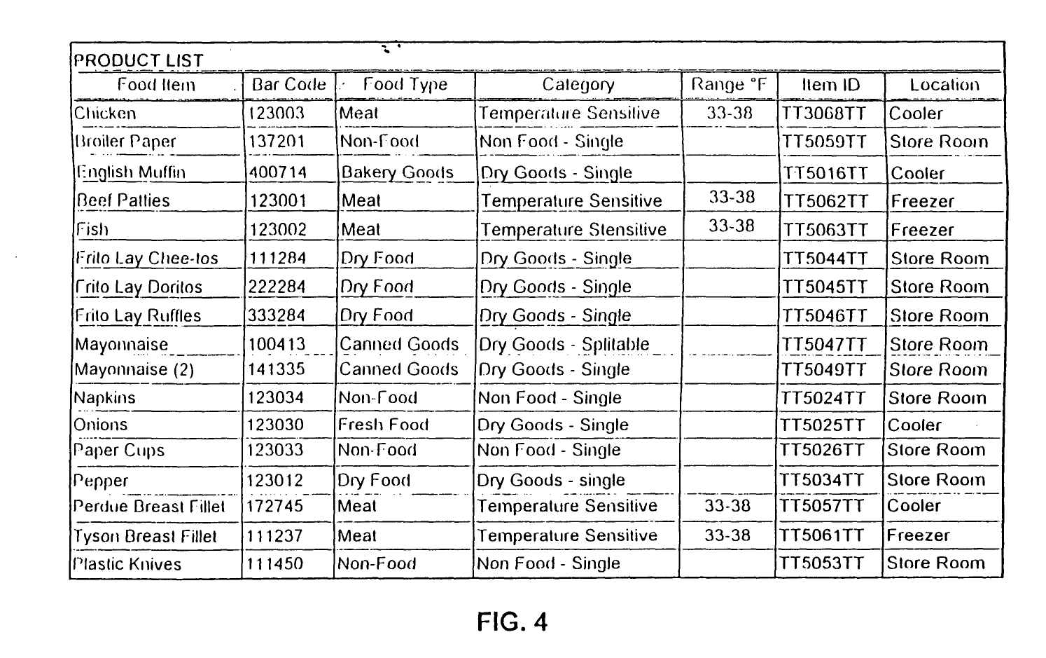

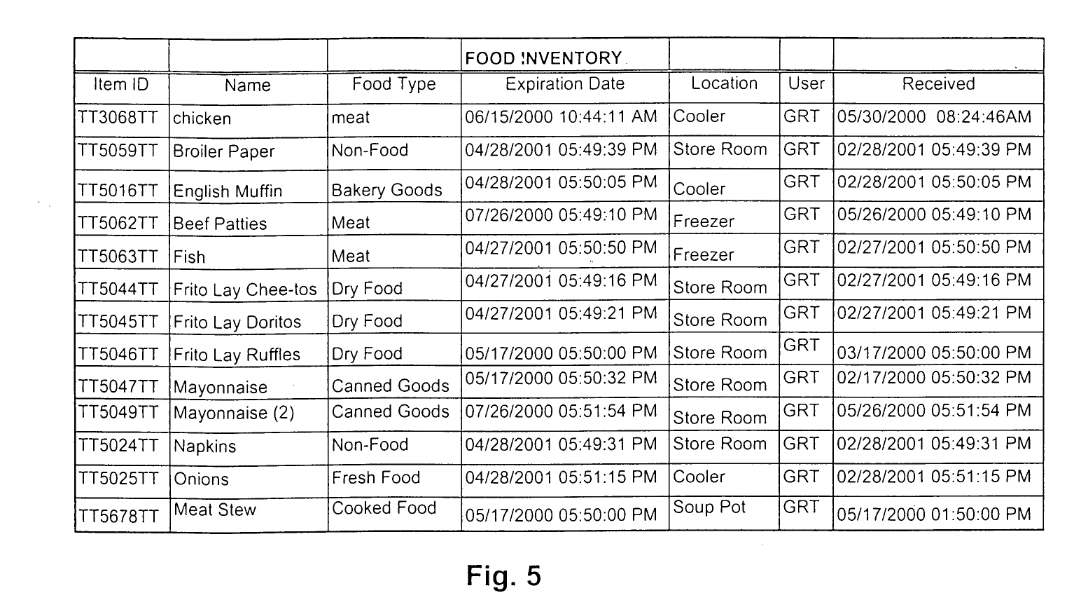

The central computer 24 contains various tables containing the information shown in FIG. 4 which represents a list of all products that may be found at any time in the food processing facility. Thus, the computer is programmed with each bar code expected to be read, the name of the food item associated with the bar code, the food type of the food item, a digital identification code for the food item, a receiving temperature range, a default or initial storage location, if any, for the food item, an indication of whether the food item is temperature sensitive, etc. With the table of FIG. 4, the computer 24 is able to add the scanned food item to an inventory table shown in FIG. 5. The inventory table lists each food item in the food processing facility by its digital identification code and for each digital identification code, includes the food item name, the food type, its location, the initials of the person entering the data, the time and date the food item was received, the acceptable temperature range of the food being received, etc.

If there is no default storage location, the central computer 24 sends a message to the data collector 22 for display on the data collector visual display 47 asking the user where the food item is to be located. All potential locations for the food have a digital identification code which can be entered by the user with the keypad 45. Alternatively, the digital codes of the different locations can be reproduced in bar code form on a placard that is posted at the location of the user receiving and scanning the food item. Thus, the user can simply scan the bar code of the location to which the food item is to be moved. The bar code is decoded by the processor 28 and then transmitted to the central computer 24. The central computer 24 stores a table associating the decoded bar code indicia with a specific location, and the computer 24 enters the identity of the specific location into the inventory table of FIG. 5. As will be appreciated, the table of FIG. 5, as well as the other tables illustrated, are presented in human readable form; however, the computer 24 normally stores table data in machine readable code.

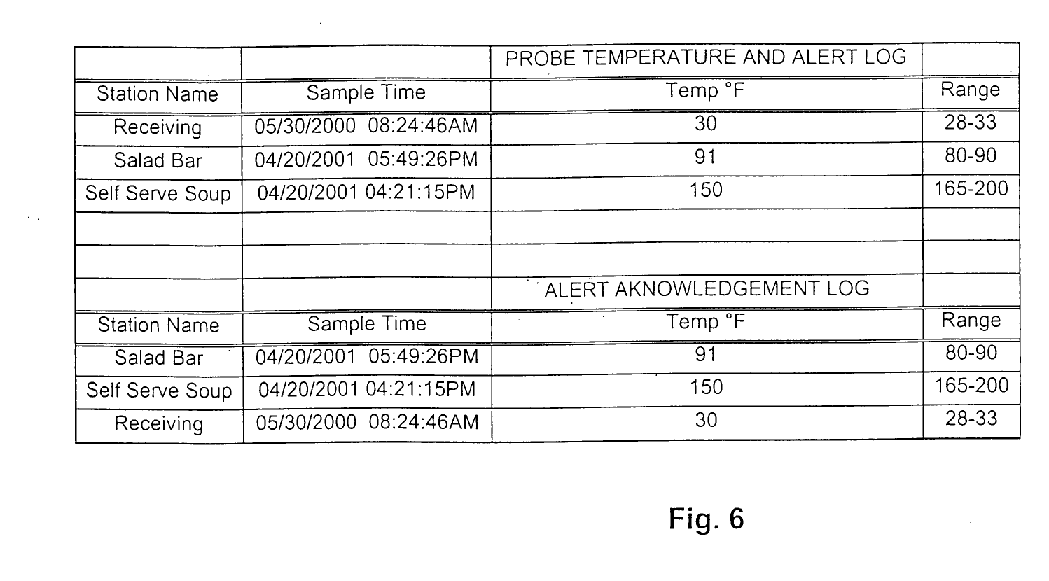

Next, upon a prompt from the computer 24, the user uses the probe 30 to measure the temperature of the food package 50, and that temperature value is transferred to the central computer 24 via the remote transceiver 42, base transceiver 41 a and ethernet hub 43. The central computer 24 stores the measured temperature value along with a time and date stamp and the food item location in a table such as that shown in FIG. 6. The table of FIG. 6 also contains ranges of acceptable temperature values that are dependent on the location at which the temperature measurement was taken. That temperature range information is obtained from a table of locations and acceptable ranges of temperature at those locations which has been programmed by the user and store in the computer 24.

The central computer 24, at 304, executes an HACCP analysis using the programmed the receiving temperature range in FIG. 4 to determine whether the food packages entering the facility conform to accepted temperature specifications. While not mandated, the HACCP analysis provides temperature and time specifications that are widely accepted and followed in the food handling and processing industry. If, at 305, the HACCP analysis results in detecting a nonconformance of the measured temperature with desired temperature specifications, then, at 306, an alert is activated. The alert may be audible, visual or any sensory perceptible alarm and can be activated at the central computer 24. However, normally, an alert signal is transmitted from the central computer 24 to the hand-held data collector 22; and an audible, visual or other alert signal is presented to the user of the data collector 24. For example, the computer 24 may either instruct the user to print or, directly command the printer 34 to print, a reject label. Alternatively, the computer 24 may send a message to the data collector 22 displaying the out of range reading and allow the user of the data collector 22 to make a decision. Alternately, the computer 24 may send a message to the data collector 22 to call a manager for a decision. In a further alternative, one or more of those corrective actions may be taken depending on how far out of range the measured temperature is. In addition, other alert signals may be automatically transmitted to an offsite location, for example, an office location where out-of-temperature data is monitored. As shown in FIG. 6, the system also maintains a table of alerts and the corrective action taken. If on receiving out of temperature food, a decision other than to reject the food item is made, the system requires that some entry of a corrective action be made.

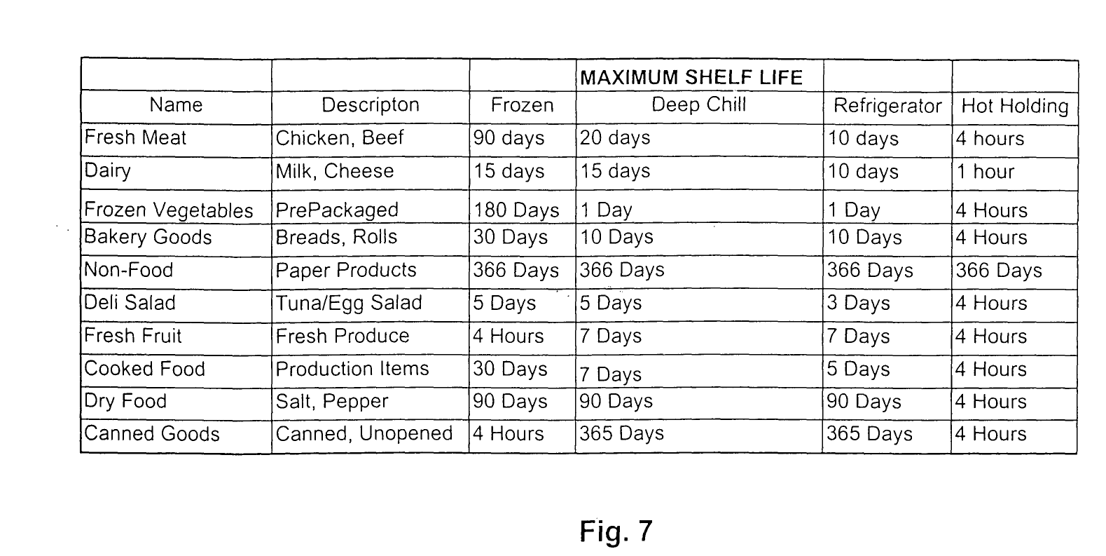

The HACCP analysis, at 302, also determines an expiration date, that is, the date after which the food package should not be used. The central computer contains a shelf life table, as shown in FIG. 7, that lists all food types that may be found in inventory, all food items associated with each of the food types and the shelf life of each food type at each location in the facility. Thus, knowing the food type and location information, the computer 24 reads a shelf life value from the shelf life table and then calculates an expiration date for the food item. The expiration date is then stored in the inventory table of FIG. 5 in association with the food item.

The computer 24 then creates data for a product rotation label. The information on a product rotation label is determined in advance by the user and often contains the name of the food item, its current location, its most recent temperature, its expiration date, etc. Further, such information is in human readable and coded form, for example, bar code form, on the label. If the central computer 24 does not have all of the information required for the product rotation label, such information is requested from the user by sending a message to the visual display 47 of the data collector 22. The data to be included on the product rotation label is then, at 307, transmitted via the ethernet hub 43, base transceiver 41 a and remote transceiver 42 back to the microcontroller 38 within the portable hand-held data collector 22.

Thereafter, at 309, the computer 24 either instructs the user to print or, directly commands the printer 34 to print, the first product rotation label 52 (FIG. 2) which is then applied to the incoming food package 50. At this point, the incoming food package has been identified, entered into the system inventory, checked for temperature and assigned to its next location.

Then, at 310, the food package 50 is transferred to its destination, for example, a food processing station, a cold storage facility, etc. For purposes of this example, assume, at 312, it is determined that the food package 50 is to be transferred to a chiller. Again, the process of transferring the food package 50 with the first product rotation label to the chiller will differ from one facility to another. In one facility, the person receiving the food package may also immediately place the food package in the chiller. In other facilities, the food package 50 may be manually or automatically transported to the chiller by the same or a different person. Further, each facility may or may not have a formal process for placing the food item into the chiller. Again, if so, the process is initiated by the user of the data collector 22 manually entering a process number or scanning a bar code associated with the process. For purposes of this example, the following process is to be executed.

The person placing the food package in the chiller, at 314, uses the scanner 40 of the data collector 22 to scan the first rotating product label, thereby sending an identity of the food package 50 to the central computer 24. Next, the user of the data collector 22 enters the code identifying the chiller unit. The chiller unit will have a placard on or adjacent the unit which provides the identification code of the unit in both human readable and machine readable form. Thus, the code is entered using the keypad 45 or scanned in using the scanner 40. In either event, the chiller unit code is transferred to the central computer 24 which updates the inventory table of FIG. 5 with the new location of the food package 50.

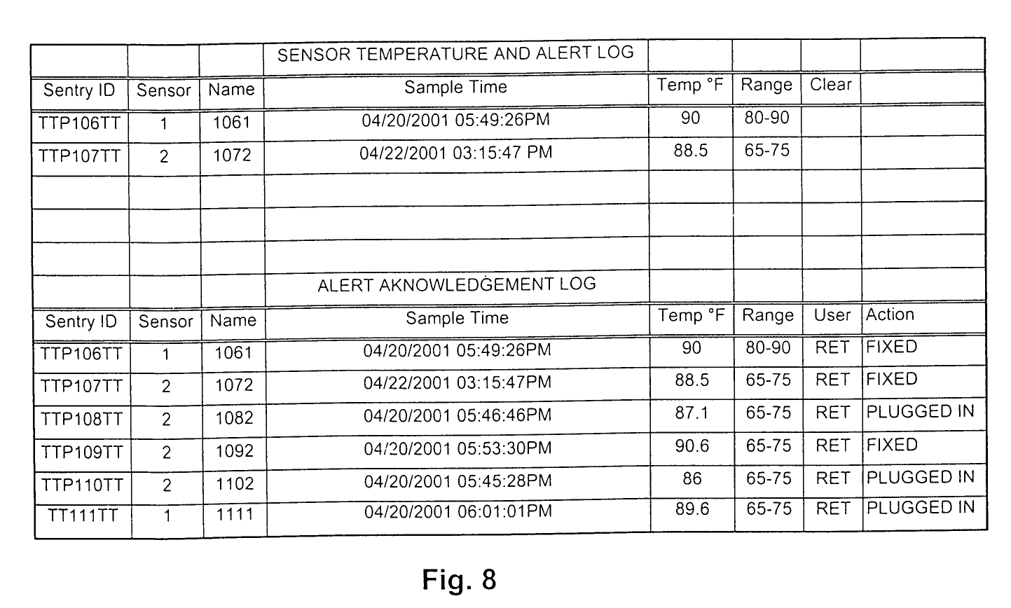

As previously described, many of the food locations, for example, freezers, chillers, refrigerators, etc. have dedicated temperature sensors for measuring the temperature maintained by the storage unit. Further, it is assumed that the food associated with that location is being maintained at the same measured temperature. Therefore, on a periodic basis that can be individually selected for each temperature sensor, the central computer 24, at 316, requests that a remote transceiver 62 or base unit 66, as appropriate, transmit the most recently monitored temperature value to the central computer 24. That measured temperature value is then stored in a sensor temperature table, as shown in FIG. 8, that chronologically lists a digital code identifying the remote transceiver 62 or base unit 41 to which the temperature sensor 60 is connected. Further, the table of FIG. 8 stores the port to which the temperature sensor is connected, the time and date stamp of the temperature value, the measured temperature value, the acceptable temperature range, etc.

The computer 24, at 316, performs an HACCP analysis to make sure that the handling of the food package 50 conforms to the desired temperature specifications. If, at 317, the central computer 24 determines that the temperature of the food does not conform to the desired temperature specifications, then at 318, an alert is actuated. Again, any sensory perceptible alert may be used at either or both the central computer and the data collector 22. The alert at the data collector 22 signals the user that the cold storage unit is outside temperature specifications. The computer 24 maintains, in FIG. 8, an alert acknowledgment log table identifying the corrective action taken which must be entered by the user either at the central computer 24 or using the data collector 22.

Often, a food package 50 is moved from one cold storage unit to another, for example, from a freezer to a refrigerator. To place a food item in the refrigerator, the user again scans or enters a process code for that action; and the central computer 24 provides messages via the display 47 to step the user through the process. In this example, after determining, at 312, that the food item is being moved to cold storage, the computer 24, at 311, determines whether a new product rotation label is required. The existing label on the food item was put on when the food item was put into the freezer, and therefore, a new label relating to the refrigerator location is required. The user is prompted to enter the location code for the refrigerator which is scanned in from a bar code on the refrigerator or manually entered via the keypad 45. The central computer 24 then, at 313, runs a portion of the HACCP analysis to determine a new expiration date. Knowing the expiration date of the food item in the freezer and the date that the food item was placed in the freezer, the computer 24 can determine the remaining shelf life of the food item. Next, knowing the food type and location, the computer 24 determines the shelf life of the food item at its current location from the shelf life table of FIG. 7. If the remaining shelf life is greater than the normal shelf life of the food item at its current location, that is, the refrigerator, the computer 24 then calculates a new expiration date based on the normal shelf life of the food item in a refrigerator. However, if the remaining shelf life is less than the normal shelf life, the computer 24 calculates a new expiration date based on the remaining shelf life. The computer 24 enters the new location and the new expiration date of the food item into the inventory table of FIG. 5 in association with the identification of the food item.

In addition, often the computer 24 composes a new product rotation label including the new location of the food item and the new expiration date and sends that new product rotation label to the remote data collector 22. As before, the computer 24 either commands the printer 34 to print, or instructs the user to print, a new label; and the user applies the new product rotation label on the food package 50 either over the old product rotation label or after removing the old product rotation label. Thereafter, the process of steps 314-318 are repeated. The user, at 314, scans the new product rotation label upon placing the food item in the refrigerator, and at 316-318, temperature readings from the refrigerator are sampled and analyzed. It should be noted that the process of FIG. 3 is only illustrative in nature. Temperature measurements are continuously being sampled and analyzed for all fixed temperature sensors on all cold storage units, hot holding stations, etc.

When the user desires to make a recipe, at 319, the user enters the identity of the recipe, for example, meat stew, in the central computer 24. Again, to simplify use of the system, a placard may be placed in the facility that has codes for all the available recipes in human readable and bar code forms. The recipe code is entered manually via the keypad 45 or the scanner 40. The central computer 24, at 320, first creates a batch number for the meat stew recipe, that is, a number that uniquely identifies prepared meat stew. The computer 24 then scans the inventory table and identifies the food item ingredients of the recipe that have the oldest expiration dates, thereby reducing the probability of a loss of food through spoilage. Next, a hard copy of the recipe is printed. Printers 70 can be connected to the central computer 24 or any of the base transceivers 41 and placed at different locations within the food processing facility Thus, a user can have the recipe printed at any convenient location. With the printed recipe, a person with a remote data collector 22 selects an ingredient, for example, chicken, and goes to the location of the chicken, for example, a chiller. Then, at 322, the first product rotation label 52 on each package of chicken within the cold storage unit is scanned with the scanner 40. If, at 324, the information on the bar code label 52 does not correspond to the desired package identified by the central computer 24, no signal is given. However, when the user scans a food rotation label of chicken having an expiration date corresponding to the expiration date identified by the central computer 24, at 326, an audible signal is produced by the audio signal generator 46 which identifies that package of chicken as the one that should be used. As will be appreciated, while an audio signal is more efficient to identify the food package, the audio signal may be complemented or substituted with a visual message on the display 47.

It should be noted that each time a product rotation label is scanned, the computer 24 is always checking the expiration date to determined whether it has expired. If it does detect an expired expiration date, an alert is issued to the user via the computer 24 and/or the data collector 22. Further, the expired food item will be highlighted or otherwise identified on any screen displaying the food item. Further, the user at any time can create a listing of all food items that are about to, or have, expired.

After all of the food items required for the recipe are found, at 330, and delivered to a food processing station, the computer 24, at 332, transmits to the visual display 47 of the data collector the instructions for using the food items to make the recipe, in this example, meat stew. Assume in this example that because of the extended cooking time for meat stew, it is desirable at this time to print and apply a new product rotation label. Therefore, at 333, the computer 24 sends a new product rotation label including the batch number for the meat stew assigned by the computer 24 and a location code of the food processing station to the data collector 22. The computer 24 may, at 334, either, directly command the printer 34 to print, or, instruct the user to print, the new product rotation label which is then placed on, or at a location adjacent, the food processing station. A dedicated temperature sensor 60 may, at 335, be used in a cooker or a utensil to measure the temperature of the meat stew being prepared. On a periodic basis, the computer 24 requests that the remote transceiver 62 transmit the most recently measured temperature to the computer for storage. The computer 24 stores the measured temperature with a time and date stamp in a table as shown in FIG. 8 of measured temperatures. Alternatively, the user may use the probe 30 of the remote data collector 22 to measure the temperature of the meat stew being prepared in addition to, or in place of, the temperature sensor 60. When the temperature is measured with the temperature probe 30 of the data collector 22, the user then scans the product rotation label containing the batch number of the meat stew and the location at which the food is being prepared. Alternatively, that information may be manually entered with the key pad 45. When using the data collector 22, the computer 24 updates the probe temperature table of FIG. 6.

At 336, the central computer 24, upon receiving each measured temperature value from the food preparation process, performs an HACCP analysis to determine whether the preparation of the meat stew corresponds to the recommended temperature specifications. If at 337, the computer 24 detects that the temperature does not conform to the temperature specifications, then at 338, an alert is sounded. Again, the alert is any sensory perceptible alert and may be presented at the computer 24, the data collector 22 or the location of the food processing station. The user is thus advised that the food being prepared is out of the desired temperature specification, and the appropriate corrective action is then taken. Again, the computer 24 may maintain a log of all of such out of range temperatures as well as the corrective action taken.

When the meat stew recipe is completed, it may, at 339, be placed in cold storage or served. If the meat stew is to go to cold storage, for example, a freezer, chiller or refrigerator, the process as previously described with respect to steps 311 -318 is executed. If, at 339, it is the meat stew is to be served, the food is moved to a serving station. The data collector 22 is used to enter a process for moving the meat stew to a particular serving station, and the central computer 24 transmits messages to the data collector 22 stepping the user through the process. As part of that process, the central computer 24 determines, at 340, an expiration date for the meat stew. As before, the shelf life for cooked food is in the shelf life table of FIG. 7, and the computer 24 uses that value to determine the expiration date for the meat stew. The computer 24 also enters the meat stew in the inventory table. In addition, the computer 24 composes a new product rotation label containing the digital code identifying the batch number of the meat stew, its serving location, the new expiration date, and the temperature at which the meat stew is to be maintained at the serving station. The new product rotation label is transmitted to the data collector 22 with, at 341, either a command to the printer 34 to print, or instructions to the user to print, a new product rotation label which the user then applies on the container holding the food or at a location adjacent the food.

At different times during the serving process, the temperature of the meat stew being served is measured and transmitted back to the computer 24. In the same manner as previously described with respect to a food preparation station, the temperature of the meat stew being served may be measured by a dedicated temperature sensor 60 or the temperature probe 30 of the data collector 22 and transmitted back to the computer 24. Further, as previously described, the central computer 24 stores the measured temperature values in the appropriate tables with a time and date stamp and other information as previously described. At 344, an HACCP analysis is performed, and if the temperature of the meat stew being served falls outside the recommended temperatures as detected at 346, an alert is activated at 348. The alert may be an audible and/or a visual alert that is activated at the food serving station, and/or the alert may be remotely located in the kitchen, and/or the alert may be activated at the central computer 24 in audible or visual form. Corrective action must then be taken to clear the alert.

The above is only one example of how the monitoring and tracking system of the present invention can be implemented. By having an accurate record of the age of all food items in inventory, the user can print a report of the food items in inventory that is sorted by expiration date. Thus, each day the user knows exactly what foods are about to exceed their shelf life and select daily recipes so that all of the oldest foods are used within their recommended shelf lives.

In another implementation, the user has the option of entering a manufacturer's lot number into the inventory table of FIG. 5. If used, the computer 24 requests the user to enter the number as part of the process of receiving a food item into inventory. Normally, the manufacturer's lot number is printed on the food item label in human readable form; and therefore, the user must enter the number using the keypad 45. Thus, if a manufacturer issues a recall of food items produced in a particular lot number, the monitoring and tracking system can be commanded to print a report that is sorted on the basis of the recalled lot number. Therefore, the user can accurately and immediately determine if there are any food items in inventory that were manufactured in the recalled lot number. If so, the user can execute a recall process with the computer 24. As part of that process, a list of the food items having the recalled lot number can be printed, and those food items identified and removed from inventory pursuant to processes previously described. Alternatively, the computer 24 can transmit to the data collector 22 the location and item name of the food item. Therefore, the user can quickly sort through the inventory at that location and remove the desired food items. In another implementation, the user can choose to have the lot number printed on the product rotation label; and in that situation, the scanner 40 can be used to identify all food items at a particular location that have the recalled lot number.

In other situations, often food items in a recalled lot number have been used and consumed prior to the receipt of the recall notice. With manual systems, the manufacturer's lot number is often not recorded, and therefore, it is impossible to determine whether any recalled food items were received or consumed. Therefore, there is no way to verify or disprove complaints made by customers with respect to prepared foods that possibly could have been made from food in recalled lots. However, with the present invention, if complaints are received with respect to a particular prepared food, the time and date that the recipe was prepared and served can be accurately and quickly determined. In addition, the food items and the lot numbers of the food items used in the recipe can also be accurately and quickly determined. Therefore, a link between the complaint and the recalled lot of food items can be accurately and almost instantaneously established or not. The ability to accurately and quickly prove or disprove a link between a complaint and food items in a recalled lot, permits a resolution of such situations with more certainty and efficiency.

The above-described monitoring and tracking system as used in a food handling and processing facility has several significant advantages. First, the temperature of the food at different locations in the facility is automatically measured, transmitted to a central computer and stored. Further, an analysis of the measured temperatures is automatically performed with respect to specific food types and the type of location for example, cold storage, cooking pots, serving trays, etc. In addition, alerts are provided to the user in the event that the temperatures are outside their recommended temperature range. For many locations, the temperature measuring, storing, analyzing and reporting is done without the requirement of any labor. Thus, the monitoring and tracking system of the present invention has the advantages of continuously, very accurately and reliably monitoring, tracking and analyzing temperatures as a function of particular food types which heretofore was only performed manually and thus, could not be continuously performed.

The monitoring and tracking system of the present invention automatically recalculates as necessary and tracks the changing shelf life and expiration dates of all food items in inventory and at all stages of the food preparation process. Further, as food items are moved through the food handling and processing facility, the present invention permits new product rotation labels to be accurately and quickly printed on the floor at the location where the label is to be applied. Further, the label includes all pertinent information in coded as well as human readable form so that the information on the label can be accurately and quickly entered into the system by a scanning process.

In addition, as recipes are selected, the monitoring and tracking system of the present invention automatically identifies the oldest food items in inventory and their respective locations, and the system provides an accurate and efficient semiautomatic process for finding those items at their locations. Thus, the ingredients with the oldest expiration dates can be accurately and quickly found, so that food items do not spoil in inventory. This feature can completely eliminate spoilage and having to dispose of food in inventory which represents a substantial savings to the user.

Further, the monitoring and tracking system of the present invention can quickly and accurately determine whether food items associated with a manufacturer's recalled lot number have been brought into inventory. Further, the exact date those food items were used in a specific recipe and ultimately consumed can also be accurately, easily and quickly determined. Thus, the system has the advantage of accurately and quickly being able to identify recalled food items as well as accurately verify whether complaints correspond to the use of recalled food items in specific recipes on specific days. Thus, any such complaints can be expeditiously handled with a high level of confidence and certainty.

The monitoring and tracking system of the present invention has all of the above-described features in a single system that is very flexible in that the user can define any number of process steps in as few or as many processes as desired. Further, while it is important that product rotation labels contain an identity of the food item and its expiration date, the user can print any other information on the label, as desired. Further, the user has great flexibility in choosing which fields in which tables to use, and the user can adjust the HACCP analysis as desired, so that a more stringent or less stringent model is implemented. Thus, the monitoring and tracking system of the present invention provides a tool for a food handling and processing system that was heretofore unavailable.

While the present invention has been illustrated by a description of various preferred embodiments and while these embodiments have been described in considerable detail in order to describe the best mode of practicing the invention, it is not the intention of Applicant to restrict or in any way limit the scope of the appended claims to such detail. Additional advantages and modifications within the spirit and scope of the invention will readily appear to those skilled in the art. For example, in the described embodiment, the sensors 30, 60, 66 are used to measure and track temperature. As will be appreciated, the sensors 30, 60, 66 may be used to monitor and track any other desired condition or state of an item. For example, the sensor may be used to sense pressure, force, airflow, weight, etc. Transducers capable of sensing such conditions are commercially available.

In the described embodiment, the communications link 26 is described as a RE wireless link in combination with an ethernet link or hub. As will be appreciated, either the wireless link and/or the ethernet hub can be replaced by any other known communications links, for example, a serial line, hard wiring, etc. Throughout the description, reference has been made to a single data collector as illustrated in FIGS. 1 and 2, however, as will be appreciated, the monitoring and tracking system will support a plurality of data collectors 22. The monitoring and tracking system 20 is described with respect to a food processing facility. Such a facility may be a food manufacturing plant producing a packaged food, for example, dried, canned or frozen foods, for the retail or wholesale markets, a meat processing facility, a produce warehouse, a restante, etc. As will be appreciated, the monitoring and tracking system may be used in other applications unrelated to the food industry.

Therefore, the invention in its broadest aspects is not limited to the specific detail shown and described. Consequently, departures may be made from the details described herein without departing from the spirit and scope of the claims which follow.

1-18. (canceled)

19. A method of monitoring and tracking temperatures of a food item comprising:
reading with a hand-held data collector a label on the food item, the label having identity data identifying the food item;
transmitting the identity data to the computer;
measuring a first temperature value of the food item with a temperature measuring device in electrical communication with the hand-held data collector;
transmitting the first temperature value of the food item to a computer from the hand-held data collector; and
storing at the computer the first temperature value of the food item in association with the identity data, so that a record of the temperature of the food item is maintained.

20. (canceled)

21. (canceled)

22. The method of monitoring and tracking temperatures of claim 19 further comprising transmitting the first temperature value from the hand-held data collector to the computer.

23. The method of monitoring and tracking temperatures of claim 22 further comprising:
transmitting temperature related data for the food item from the computer to the hand-held data collector; and
printing a label for the food item using a printer in electrical communications with the hand-held data collector, the label containing information relating to the temperature related data.

24. The method of monitoring and tracking temperatures of claim 19 wherein providing identity data further comprises providing with the computer a tracking number identifying the food item.

25. (canceled)

26. The method of monitoring and tracking temperatures of claim 19 further comprising transmitting an identity of the temperature measuring device to the computer.

27. The method of monitoring and tracking temperatures of claim 19 further comprising:
measuring a plurality of temperature values of the food item at different times with the temperature measuring device;
transmitting the plurality of temperature values of the food item to the computer; and
storing at the computer the plurality of temperature values of the food item in association with the identity data, so that a time record of the plurality of temperature values of the food item over time is maintained.

28. The method of monitoring and tracking temperatures of claim 19 further comprising:
detecting a nonconformance of the first temperature value of the food item with respect to specified temperature values for the food item; and
providing an alert signal in response to detecting the nonconformance of the first temperature value.

29. The method of monitoring and tracking temperatures of claim 19 further comprising:
measuring the first temperature value at a first location;
transmitting an identity of the first location to the computer;
measuring a second temperature value representing a temperature of the food item at a second location;
transmitting the second temperature value and an identity of the second location to the computer; and
storing at the computer the second temperature value and identities of the respective first and second locations in association with the identity data, so that a record of the temperature of the food item at different locations is maintained.

30. The method of monitoring and tracking temperatures of claim 19 further comprising:
measuring a second temperature value representing a temperature of the food item;
transmitting the second temperature value to the computer; and
storing at the computer the second temperature value in association with the identity data, so that a record of the temperature of the food item over time is maintained.

31. The method of monitoring and tracking temperatures of claim 30 further comprising measuring the first and the second temperature values at different times.

32. The method of monitoring and tracking temperatures of claim 31 further comprising measuring the first and the second temperature values at different times at one food processing station.

33. The method of monitoring and tracking temperatures of claim 31 further comprising measuring the first and the second temperature values at respective first and second food processing stations.

34. The method of monitoring and tracking temperatures of claim 31 further comprising:
detecting a nonconformance of each of the first and the second temperature values of the food item with respect to specified temperature values for the food item; and
providing an alert signal in response to detecting a nonconformance of one of the first and the second temperature values.

35. The method of monitoring and tracking temperatures of claim 31 further comprising:
measuring a plurality of first temperature values representing temperatures of the food item at a first food processing station;
transmitting the plurality of first temperature values to a computer;
measuring a plurality of second temperature values representing temperatures of the food item at a second food processing station;
transmitting the plurality of second temperature values to a computer; and
storing at the computer the plurality of the first and second temperature values in association with the identity data, so that over time a record of the temperature of the food item is maintained.

36. A method of monitoring and tracking shelf life for a food item comprising:
providing identity data identifying a food item;
identifying a first location of the food item;
automatically determining a shelf life for the food item as a function of the identity of the first location;
identifying another location to which the food item is moved; and
automatically determining and storing a new shelf life for the food item as a function of the first and other locations.

37. (canceled)

38. The method of monitoring and tracking shelf life of claim 36 further comprising updating a table providing shelf-life values as a function of different food items and locations.

39. The method of monitoring and tracking shelf life of claim 38 further comprising automatically determining a first date on which the food item is placed at the first location.

40. The method of monitoring and tracking shelf life of claim 39 further comprising automatically generating an expiration date for a food item as a function of a shelf-life value and the first date.

41. The method of monitoring and tracking shelf life of claim 36 further comprising:
determining a first date on which the food item is placed at the first location; and
automatically determining a first expiration date for the food item as a function of the identity of shelf life at the first location and the first date.

42. The method of monitoring and tracking shelf life of claim 41 further comprising:
identifying a second location to which the food item is moved;
automatically determining a shelf life for the food item as a function of the identity of the second location;
determining a second date on which the food item is placed at the second location; and
automatically determining a new expiration date for the food item as a function of the shelf lives at the first and second locations and the first and second dates.

43. The method of monitoring and tracking shelf life of claim 42 further comprising iterating steps in the process of claim 42 each time the food item is moved.

44. The method of monitoring and tracking shelf life of claim 41 further comprising automatically providing an alert in response to the new expiration date exceeding a maximum expiration date for the food item.

45. A method of monitoring and tracking shelf lives for food items comprising:
(a) receiving and storing identity data identifying food items;
(b) determining and storing a first date on which each of the food items is placed at a first location;
(c) automatically determining and storing
(1) a first shelf life for each of the food items as a function of the first location and
(2) a first expiration date for each of the food items as a function of the first shelf life and the first date;
(d) receiving and storing data identifying a second location to which one of the food items is moved;
(e) determining and storing a second date on which the one of the food items is placed at the second location; and
(f) automatically determining and storing
(1) a second shelf life for the one of the food items as a function of the second location and
(2) a new expiration date for the one of the food items as a function of the first and second shelf lives and the first and second dates.

46. The method of monitoring and tracking shelf lives of claim 45 further comprising iterating steps (e) and (f) each time one of the food items is moved to a new location.

47. The method of monitoring and tracking shelf lives of claim 45 further comprising automatically providing an alert in response to the new expiration date exceeding a maximum expiration date for the one of the plurality of food items.

48. The method of monitoring and tracking shelf lives of claim 45 further comprising:
automatically calculating expiration dates for all of the food items having first identity data in response for a request to use a food item having the first identity data;
automatically identifying a food item having a closest expiration date; and
automatically providing an output identifying a location of the food item having the closest expiration date.

49. The method of monitoring and tracking shelf lives of claim 48 further comprising:
receiving input data corresponding to the food item having the closest expiration date; and
automatically providing an output signal in response to receiving the input data corresponding to the food item having the closest expiration date.

50. A method of monitoring and tracking a food lot number for a food item comprising:
providing and storing in a monitoring and tracking system identity data identifying food items and food lot numbers associated with respective ones of the food items, each food lot number identifying a specific lot from which the food item was made by a particular manufacturer; and
generating a report using the monitoring and tracking system to identify the food items associated with a lot number input by a user.

51. The method of monitoring and tracking a food lot number of claim 50 further comprising:
providing and storing a plurality of location codes representing respective locations at which each of the food items has been located in food handling and preparation processes; and
automatically generating a report using the monitoring and tracking system to identify locations of the food items associated with a lot number input by a user.

52. The method of monitoring and tracking a food lot number of claim 50 further comprising:
providing and storing prepared food codes representing foods prepared using the food items; and
automatically generating a report using the monitoring and tracking system to identify prepared foods using food items associated with a lot number input by a user.
